(19) United States
(12) Patent Application Publication
(10) Pub. No.: US 2010/0191563 A1
(43) Pub. Date: Jul. 29, 2010

(54) Physician Practice Optimization Tracking

(75) Inventors: David A. Schlaifer, Tampa, FL (US); Cary J. Auderer, Largo, FL (US); Amanda Edenfield Patanow, St. Petersburg, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(73) Assignee: Doctors' Administrative Solutions, LLC, Tampa, FL (US)

(21) Appl. No.: 12/692,806

(22) Filed: Jan. 25, 2010

Related U.S. Application Data
(60) Provisional application No. 61/205,800, filed on Jan. 23, 2009.

(51) Int. Cl. G06Q 10/00

(52) U.S. Cl. 705/7

(57) ABSTRACT

A computer-implemented method for tracking of clinical, demographic, financial and service metrics within a physician practice and comparing such metrics to other physician practices comprising: running a data collection service in the background on at least two separate physician practice modules wherein the data collection service collects data from the particular module on which it is running; establishing a communication mechanism between each data collection service and a host module; at the host module, collecting the data from the data collection services by transmitting the data from the data collection services via the communication mechanism to the host module; storing the data in the host module; comparing the data in the host module against best practices data stored in the host module wherein for each of a predetermined set of data metrics, the best practices data associated with that data metric is computed in relation to the data collected for a plurality of practices reporting that data metric; displaying to a user, via an interface, the data stored in the host module; and allowing the user to filter the data displayed wherein the user can filter the data by predetermined filter criteria comprising practice size, location, and specialty.

### CROSS-REFERENCE TO RELATED INVENTIONS

This application claims the benefit of U.S. provisional application No. 61/205,800, filed Jan. 23, 2009.

### BACKGROUND OF THE INVENTION

1. Field of the Invention

This disclosure relates generally to the field of identifying key clinical, demographic, financial and service metrics within physician practices and, more specifically, to providing a means of easy comparison between those metrics and other physician practices.

2. Description of the Background Art

Presently, there exist numerous systems that provide physician practices with a method of tracking patient demographic, financial, and scheduling information (“Practice Management Systems” or “PM Systems”). There also exist numerous systems that provide means and methods for documenting patient clinical information (“EHR Systems”), and still other systems that provide the combined functionality of PM Systems and EHR Systems (“PM/EHR Systems”). In addition, there are several claims clearinghouses that exist for the purpose of electronically submitting claims and, in some cases, receiving electronic remittances (“Clearinghouse(s)”).

Also, there presently exist various forms of systems that provide data in a consolidated fashion, frequently known as “dashboards”.

It is desirable to have a system that collects data from numerous like and disparate PM/EHR Systems and/or Clearinghouses and compares such data in a way that enables the user to determine ways to better optimize the financial, service, and other results of the physician practice.

Therefore, it is an object of this disclosure to provide an improvement which overcomes the aforementioned inadequacies of the prior art devices and provides an improvement which is a significant contribution to the advancement of the physician practice management art.

It is another object of this disclosure to provide an improvement in the physician practice management art which enables the comparison of numerous physician practices to other physician practices to identify key best practices.

The foregoing has outlined some of the pertinent objects of the disclosure. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this disclosure, this disclosure comprises a computer-implemented method for tracking of clinical, demographic, financial and service metrics within a physician practice and comparing such metrics to other physician practices comprising: running a data collection service in the background on at least two separate physician practice modules wherein the data collection service collects data from the particular module on which it is running; establishing a communication mechanism between each data collection service and a host module; at the host module, collecting the data from the data collection services by transmitting the data from the data collection services via the communication mechanism to the host module; storing the data in the host module; comparing the data in the host module against best practices data stored in the host module wherein for each of a predetermined set of data metrics, the best practices data associated with that data metric is computed in relation to the data collected for a plurality of practices reporting that data metric; displaying to a user, via an interface, the data stored in the host module; and allowing the user to filter the data displayed wherein the user can filter the data by predetermined filter criteria comprising practice size, location, and specialty.

Various other embodiments of the invention may have none, some, or all of the advantages discussed herein. Other technical advantages of the present disclosure will be readily apparent to one skilled in the art.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 illustrates an example of a physician practice management system in accordance with one embodiment of the present disclosure.

FIG. 2 illustrates an example of the architecture of a user interface in accordance with one embodiment of the present disclosure.

FIGS. 3-8 illustrate a user experience for analyzing data as displayed in one embodiment of the present disclosure.

FIG. 3 illustrates an aggregate view of the data as displayed in one embodiment of the present disclosure.

FIG. 4 illustrates an aggregate view of the data with a filter applied as displayed in one embodiment of the present disclosure.

FIG. 5 illustrates an aggregate list of practices as displayed in one embodiment of the present disclosure.

FIG. 6 illustrates a practice level detail as displayed in one embodiment of the present disclosure.

FIG. 7 illustrates a practice view as displayed in one embodiment of the present disclosure.

FIG. 8 illustrates a practice view showing filter and best practice identification as displayed in one embodiment of the present disclosure.

Similar reference characters refer to similar parts throughout the several views of the drawings.

### DETAILED DESCRIPTION OF THE PREFERRED EMBODIMENT

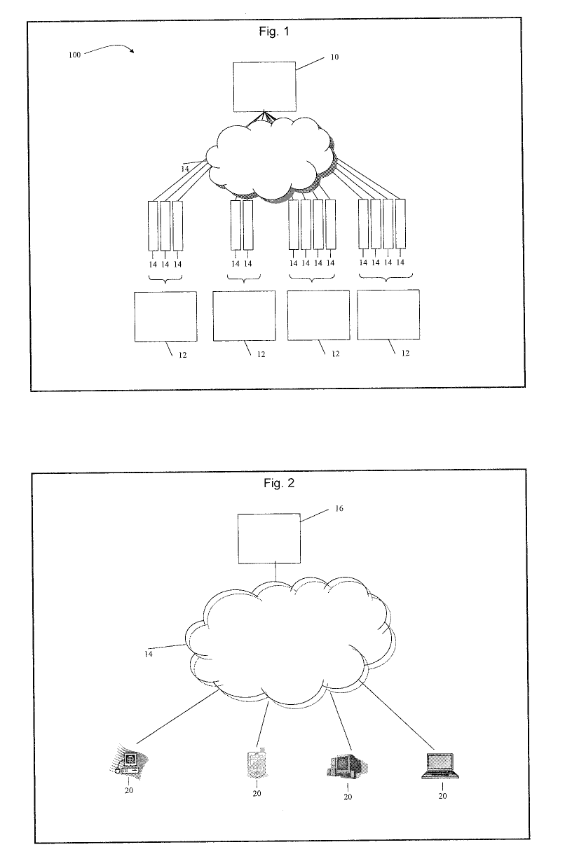

FIG. 1 is a high-level diagram depicting an architecture for the system 100 described herein. The system 100 includes a host module 10. Each of a number of physician practices 12 gather and maintain various data associated with that practice. For instance, a physician practice 12 could maintain information about the financials of that practice, including accounts receivable information, patient scheduling information, and clinical information.

The accounts receivable information could include all information associated with all billings and financials of the physician practice 12. The patient scheduling information could include all appointments made, how often those appointments are kept or broken, regular and irregular appointments, or any other information associated with patient scheduling.

The clinical information could include information about procedures performed and outcomes, and any other relevant information. Of course, the foregoing is merely exemplary, and any information used by or in connection with a physician practice 12 could be stored, maintained or used by the physician practice 12.

Returning to a description of the system 100, each physician practice 12 would have a data collection module 14 for one or more of the various pieces of information (also referred to herein as metrics) collected by the physician practice 12. The data collection modules 14 communicate with the host module 10 by means of a communication mechanism 18. This communication mechanism 18 could be any communication mechanism, as appreciated by one of skill in the art. For example (and for exemplary purposes only, as this list does not exclude other communication mechanism), the communication mechanism 18 could be via a network, either local or wide-area, including the Internet, wirelessly via any wireless communication protocol or through any other capable communication mechanism.

The data collection modules 14 transmit the data metrics to the host module 10. The host module 10 can “pull” this information from the data collection modules 14 by requesting the information from the data collection modules 14. Similarly, the data collection modules 14 can “push” this information to the host module 10 without need for the host module to first ask for it. Any other networking architecture (for instance, client-server) would work without deviating from the present disclosure.

The host module 10 collects the data metrics and is capable of displaying the information in a number of different formats. By collecting similar metrics from different physician practices 12, the host module 10 can provide aggregate data comparing the various physician practices 12 with regards to the collected metric. Combining these metrics with demographic information about the individual physician practices 12, the host module 10 can analyze the “best practices” for the various metrics across the set of all reporting physician practices 12.

The demographic information referred to above includes, without limitation, practice size, location, specialty or any other demographic information relating to the physician practice 12. Because the host module 10 has this demographic information as well as the actual metric, the host module 10 can compare how physician practices 12 of a similar demographic (i.e. physician practices comprising 10 or less physicians) compare to one another.

Further, the host module 10 can determine a “best practice” for the various metric, and compare each of the physician practices 12 of comparable demographics with the “best practice” for a particular metric. For instance, if 90% of physician practices 12 comprising 10 or fewer cardiologist physicians has an accounts receivable aging of 30 days or less, but 10% of those physician practices 12 have an accounts receivable aging of greater than 30 days, the host module 10 can determine that an accounts receivable aging of 30 days or less for such a practice demographic would be the best practice. Carrying this example further, the host module 10 could identify those 10% of the physician practices 12 of the suggested demographic are not performing at the “best practices” level. This would enable a user of the system 100 to identify physician practices 12 that could benefit from improving in certain collected metrics as compared to other comparable physician practices 12.

Turning to FIG. 2, an overview of the user interface architecture is depicted. The host module 10 can include a user interface module 16. As would be evident to one of skill in the art, the user interface module 16 does not need to be integrated into the host module 10 (although it certainly could be). The user interface module 16 communicates via a communication mechanism 18 with various devices 20. These devices 20 can be any device capable of communicating with the user interface module 16. For instance, devices 20 could include computers, smart telephones, personal digital assistants, or any other communication device.

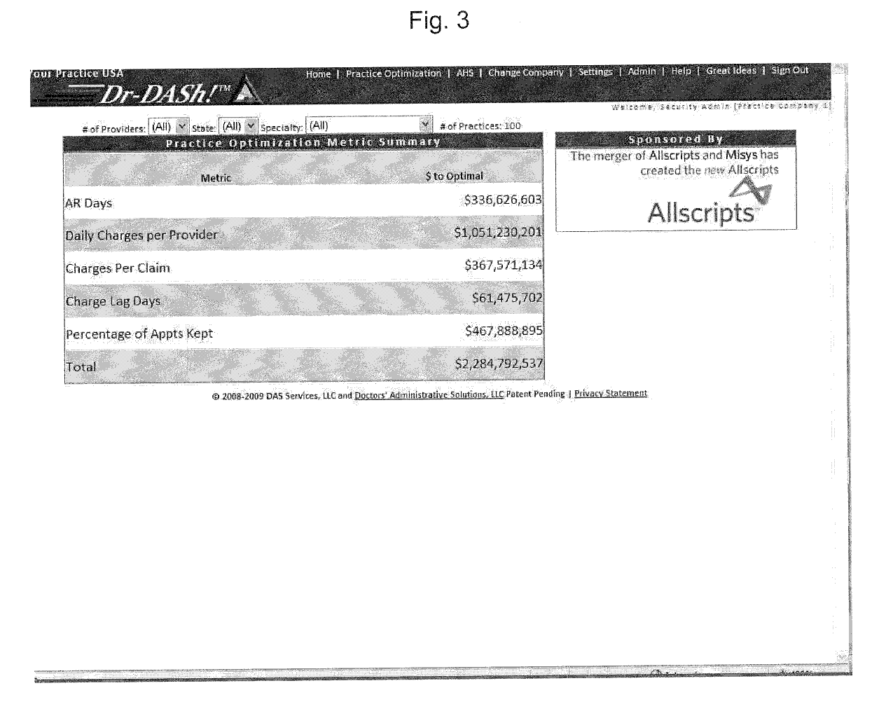

Upon accessing the user interface module 16, users are presented with an interface for mining the information stored and managed by the host module 10. FIGS. 3-8 depict some exemplary screens of such an interface, progressively showing how a user would dig through the data stored by host module 10. The system 100 allows a user to view the data stored in various formats, including at an aggregate level or including any one or multiple metrics.

The data presented to the user via the user interface module 16 can be filtered by any of the data demographics, or by any of the stored metrics. The lists can be sorted in any number of ways, as would be appreciated by one of skill in the art. One benefit of this approach is that a calculation can be made for each physician practice 12 totaling a subset (or all) of that practice's metrics. This total figure, representing a “practice opportunity” can be compared with the “best practices.” This enables a user to determine which physician practices 12 have the most potential for improvement.

“Best practices” can be calculated in a number of ways, as would be evident to one skilled in the art. In one embodiment, “best practices” is calculated as a percentage of the practices reporting a particular metric. This percentage can either be a static percentage, or a dynamically calculated percentage based upon the metrics collected in the system at the time. “Best practices” could also be a factor or related to industry reports or standards, or any other similar metric comparing mechanism. “Best practices” can also be calculated differently or specifically for a various practice area. Thus, for example, the accounts receivable best practices for a cardiology practice could be different than the accounts receivable best practices for a family practice.

“Best practices” could also be calculated in relation to clinical comparisons and metrics. For example, the data collection modules 14 could collect and report metrics relating to clinical information, such as particular diagnoses including overall cost, effectiveness, need for repeat visits, subsequent hospital stays, and other similar information pertaining to clinical information. As with any other metric analyzed by the system 100, “best practices” could be derived out of this clinical information and used for comparing the various physician practices 12 in the system to identify areas where improvement gains can be made.

The user interface module 16 is also capable of displaying advertising or other revenue generating components. In one embodiment, the system 100 can be implemented as a computer software system that runs as a service.

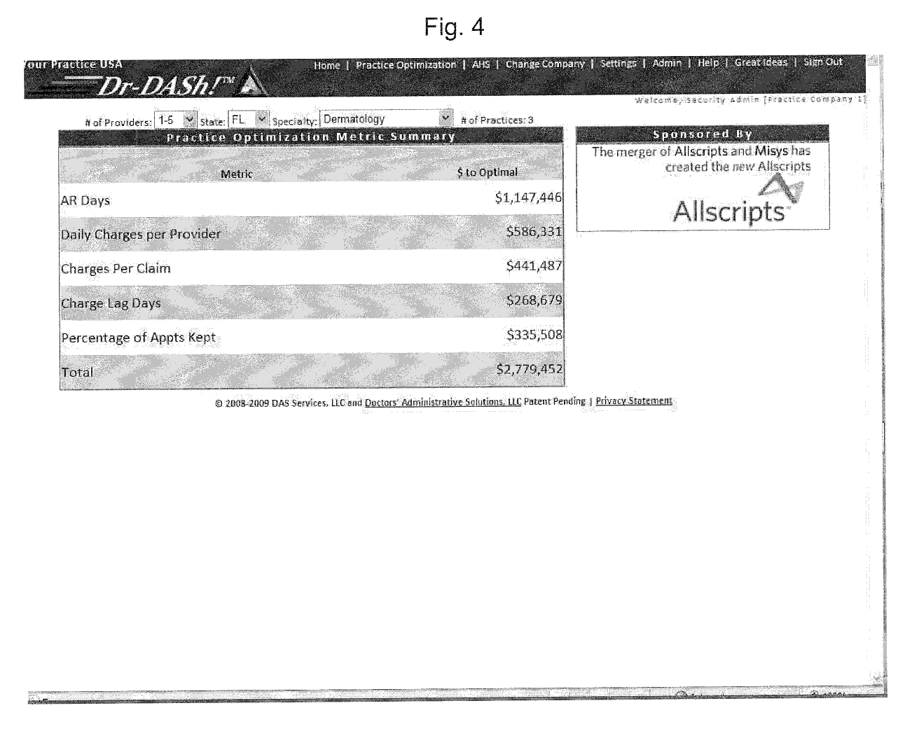

Through the user interface module 16, the user can drill down and through the data to determine whatever information is sought. The user can apply any number of filters to limit the information displayed. For instance, FIG. 3 displays an aggregate view of certain metrics throughout the system 100. In FIG. 4, the user has applied a filter—specifically, the user has limited the aggregate information to only include information about physician practices 12 with 1-5 providers, in the state of Florida specializing in Dermatology. Of course, these filters could be any information in the system, and the examples sin the Figures are exemplary.

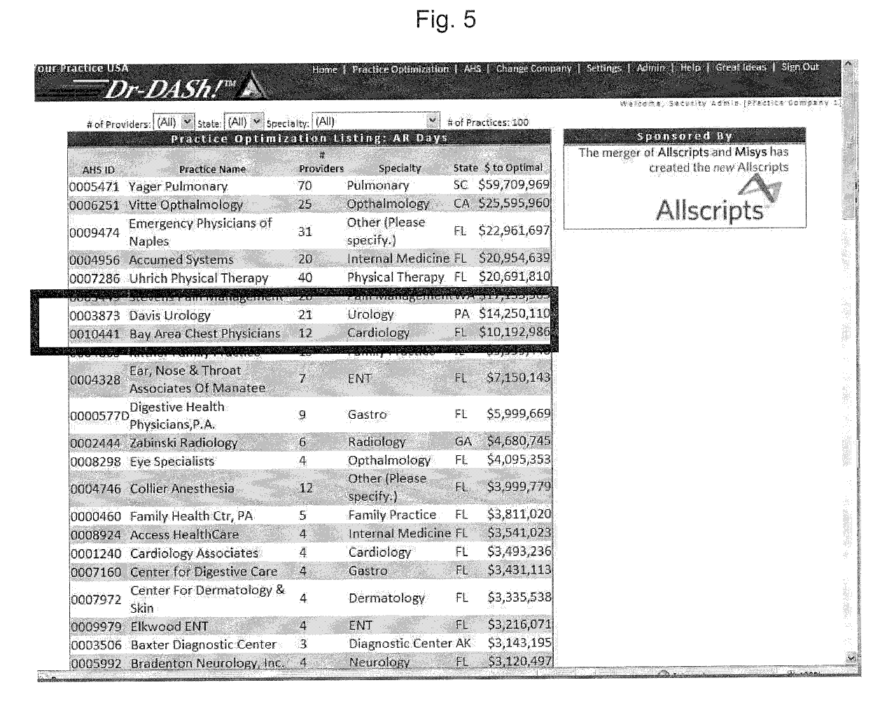

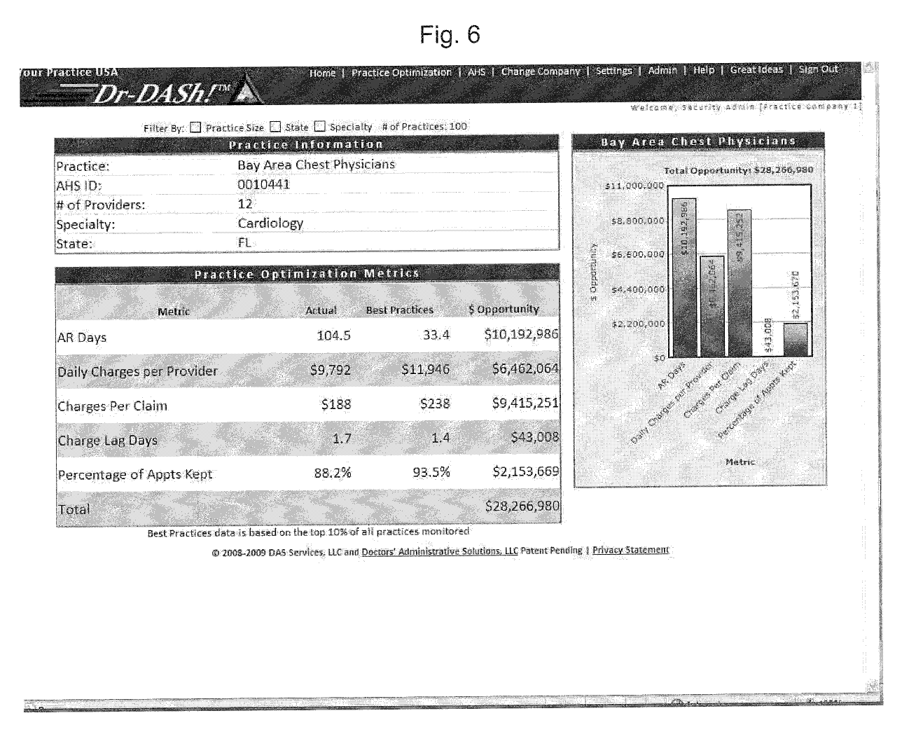

FIG. 5 displays an aggregate list of all physician practices 12 in a sample system 100. Upon selecting the “Bay Area Chest Physicians” practice, the user is presented with a display such as FIG. 5. As shown in FIG. 6, the information is now tailored to the selected physician practice 12.

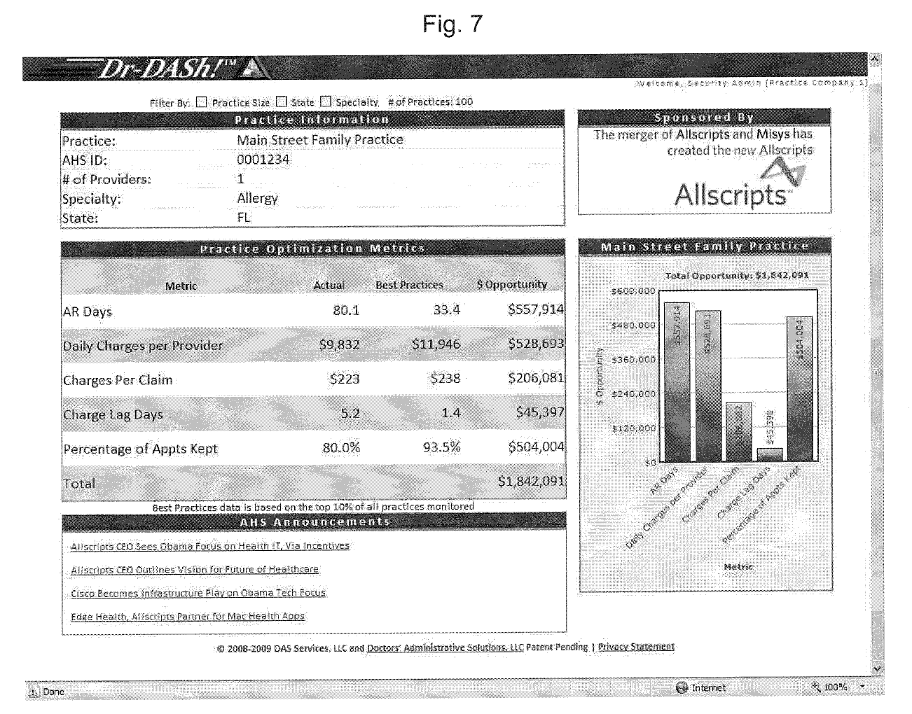

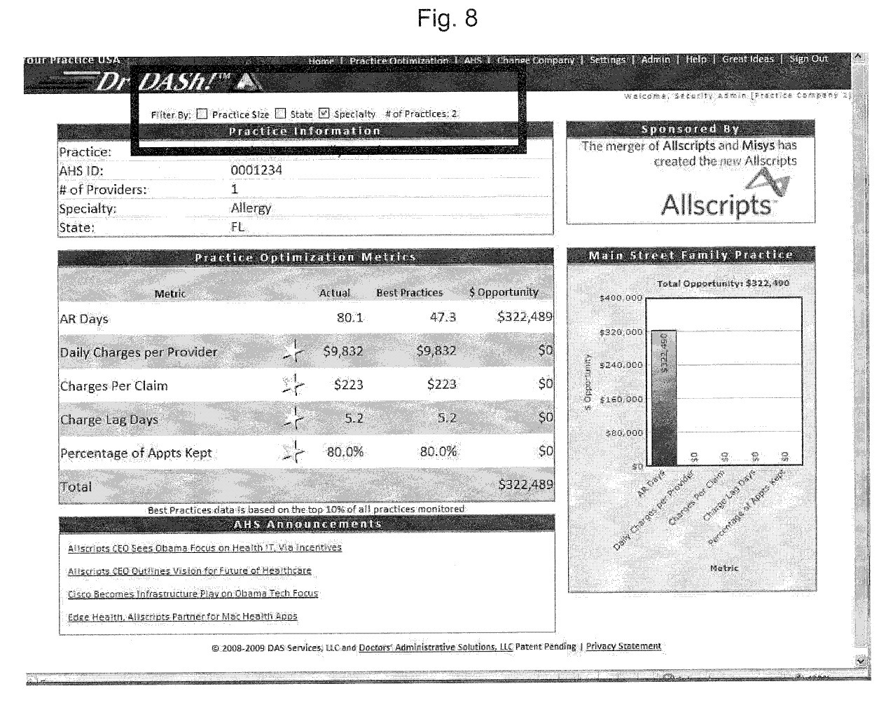

The physician practice 12 can also be presented with information tailored to that practice. As shown in FIG. 7, the practice view could information limited and pertinent to that particular practice. Members of that practice (or whomever else would have access to that information through the system 100), could then filter or compare that practice to other information stored in the system 100. For instance, the system could display how the particular practice compares to the “best practices” for any given metric. For example, FIG. 8 shows a star system for those metrics (Daily Charges per Provider, Charges Per Claim, Charge Lag Days, and Percentage of Appts Kept) where the selected practice falls within the “best practices.” Similarly, no star is displayed for those metrics (AR Days) where the particular practice does not meet the best practices. As can be seen in FIG. 8, the selected practice reports 80.1 days for AR days, but the “best practice” is 47.3 days, thus this practice does not satisfy “best practices” for that metric. On the other hand, its daily charges per provider are in line with the best practices.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A computer-implemented method for tracking of clinical, demographic, financial and service metrics within a physician practice and comparing such metrics to other physician practices comprising:
running a plurality of data collection services on separate physician practice modules wherein each data collection service collects data metrics from the particular physician practice module on which it is running;
establishing a communication mechanism between each data collection service and a host module;
at the host module, collecting the data metrics from the plurality of data collection services by transmitting the data metrics from the data collection services via the communication mechanism to the host module;
storing the data metrics in the host module;
computing in the host module best practices data in relation to the data metrics collected for a predetermined set of data metrics;
comparing the data metrics in the host module against best practices data computed in the host module;
displaying to a user, via an interface, the data metrics and best practices data stored in the host module; and
allowing the user to filter the data metrics displayed wherein the user can filter the data metrics by predetermined filter criteria comprising practice size, location, and specialty.

2. The method of claim 1 wherein the best practices data is computed as a percentage of that data metric collected from a plurality of practices reporting that data metric.

3. The method of claim 2 wherein the percentage is a predetermined percentage.

4. The method of claim 2 wherein the percentage is a dynamically-computed percentage.

5. The method of claim 1 wherein the best practices data is computed in relation to the data collected for all practices reporting that data metric.

6. The method of claim 1 wherein the data metric comprises financial information, medical claims information, and scheduling information.

7. The method of claim 6 wherein the financial information comprises accounts receivable aging information.

8. The method of claim 6 wherein the financial information comprises daily charges per provider information.

9. The method of claim 6 wherein the financial information comprises charges per claim information.

10. The method of claim 6 wherein the financial information comprises charge lag days information.

11. The method of claim 6 wherein the scheduling information comprises appointments kept information.

12. A computer-implemented apparatus for tracking of clinical, demographic, financial and service metrics within a physician practice and comparing such metrics to other physician practices comprising:
at least two data collection modules each configured to run a data collection service in the background on at least two separate physician practice modules wherein the data collection service collects data from the particular module on which it is running;
a host module wherein the host module is configured to collect data from the data collection modules by receiving;
a communication path between the host module and the first data collection module;
a communication path between the host module and the second data collection module;
wherein the host module is configured to collect and store data from the data collection modules by receiving data via the communication paths and configured to compare the data in the host module against best practices data stored in the host module wherein for each of a predetermined set of data metrics, the best practices data associated with that data metric is computed in relation to the data collected for a plurality of practices reporting that data metric; and
a display interconnected with the host module wherein the display permits a user to view the data stored in the host module.

13. The apparatus of claim 12 wherein the display is a web page.

14. The apparatus of claim 12 wherein a communication path is the Internet.

15. A physician practice management apparatus comprising:
a plurality of data collection modules for collecting a plurality of data metrics;
a host module interconnected with the plurality of data collection modules; and
a display module configured to display the data metrics collected by the host module from the data collection modules whereby the data metrics are compared to best practices metrics whereby each data metric has an associated best practices metric.

16. The apparatus of claim 15 wherein the best practice metric is calculated as a mean of all collected values for the associated data metric.

17. The apparatus of claim 15 wherein the best practice metric is calculated as a median of all collected values for the associated data metric.

18. The apparatus of claim 15 wherein the best practice metric is calculated as a predetermined percentage of all collected values for the associated data metric.

19. The apparatus of claim 15 wherein the best practice metric is calculated as a dynamically computed percentage of all collected values for the associated data metric.

20. The apparatus of claim 15 wherein the display is presented via a web page.
